(19) United States
(12) Patent Application Publication
(10) Pub. No.: US 2023/0180827 A1
(43) Pub. Date: Jun. 15, 2023

(54) DISPOSABLE RECEPTACLE FOR SMOKING PRODUCTS

(71) Applicant: EazyAsh Company, LLC, Frisco, TX (US)

(72) Inventor: Lawrence Earl Jenkins, Frisco, TX (US)

(21) Appl. No.: 18/062,320

(22) Filed: Dec. 6, 2022

Related U.S. Application Data
(60) Provisional application No. 63/265,427, filed on Dec. 15, 2021.

(51) Int. Cl. A24F 19/00; B65D 5/22; B31B 50/73

(52) U.S. Cl. CPC A24F 19/0028; A24F 19/0014; B65D 5/22; B31B 50/734

(57) ABSTRACT

A disposable apparatus for receiving waste from smoking products. Some embodiments may comprise a base panel, a plurality of side panels, and a hole in each of the side panels. The base panel may have tab slots, and each of the side panels may have tabs. Each side panel may comprise a bottom section extending from the base panel and a top section coupled to the bottom section. The apparatus may additionally comprise a base fold line between the base panel and each of the side panels and a side fold line in each of the side panels between the bottom section and the top section. The hole in each of the side panels forms a notch or groove if the top section is folded along the side fold line.

### TECHNICAL FIELD

The invention set forth in the appended claims relates generally to a disposable receptacle for ash, residue, and other waste formed from burning cigars, cigarettes, and similar products.

### BRIEF SUMMARY

New and useful apparatuses for receiving ash, residue, and other waste from smoking products are set forth in the appended claims. Illustrative embodiments are also provided to enable a person skilled in the art to make and use the claimed subject matter.

For example, some embodiments of an apparatus may comprise a base panel, a plurality of side panels, and a hole in each of the side panels. The base panel may have one or more tab slots, and each of the side panels may have one or more tabs. In some examples, each of the side panels may comprise a bottom section extending from the base panel and a top section coupled to the bottom section. The apparatus may additionally comprise a base fold line between the base panel and each of the bottom sections and a side fold line in each of the side panels between the bottom section and the top section. Each of the holes in the side panels may be aligned with the side fold line in the side panel. Each of the bottom sections may be configured to be folded at a substantially right angle along the base fold line, and each of the top sections may be configured to be folded at a substantially straight angle along the side fold line to allow each tab to be inserted into one of the tab slots in the base panel. Additionally, or alternatively, the hole in each of the side panels may be symmetrical and may form a notch or groove if the top section is folded along the side fold line. The base panel and the side panels may comprise or consist essentially of a material that is resistant to fire, such as an aluminum foil board or aluminum foil paper.

In more particular example embodiments, the apparatus may further comprise one or more corner panels, wherein each of the corner panels may extend from one of the side panels.

In other examples, an apparatus may comprise a base panel, a first side panel, a second side panel, a third side panel, and a fourth side panel. The base panel may comprise a first tab slot, a second tab slot, a third tab slot, and a fourth tab slot. The first side panel may have a first side fold line, a first hole aligned with the first side fold line, and a first tab. The second side panel may have a second side fold line, a second hole aligned with the second side fold line, and a second tab. The third side panel may have a third side fold line, a third hole aligned with the third side fold line, and a third tab. The fourth side panel may have a fourth side fold line, a fourth hole aligned with the fourth side fold line, and a fourth tab. The first side panel, the second side panel, the third side panel, and the fourth side panel may extend from the base panel at a base fold line formed around the base panel. The first side panel and the third side panel may extend from opposite sides of the base panel, and the second side panel and the fourth side panel may extend from opposite sides of the base panel. The first side panel, the second side panel, the third side panel, and the fourth side panel may be folded at substantially right angles along the base fold line. The first side panel, the second side panel, the third side panel, and the fourth side panel may be folded at substantially straight angles along the first side fold line, the second side fold line, the third side fold line, and the fourth side fold line, respectively, so that the first tab, the second tab, the third tab, and the fourth tab may be inserted into the first tab slot, the second tab slot, the third tab slot, and the fourth tab slot, respectively. The first hole, the second hole, the third hole, and the fourth hole may be configured to form a notch or groove in the first side panel, the second side panel, the third side panel, and the fourth side panel, respectively, if the first side panel, the second side panel, the third side panel, and the fourth side panels are folded at substantially straight angles. The base panel and the side panels may comprise or consist essentially of a material that is resistant to fire, such as an aluminum foil board or aluminum foil paper.

In yet other examples, a method for assembling a receptacle for ash may comprise providing a folder box that comprises a base panel tab slots, and a plurality of side panels, each of the side panels comprising a bottom section joined to the base panel at a base fold line, a top section coupled to the bottom section and having a tab, a side fold line between the bottom section and the top section, and a hole aligned with the side fold line. Each bottom section may be folded at a substantially right angle along the base fold line so that each bottom section is substantially orthogonal to the base panel. Each top section may be folded at a substantially straight angle along the side fold line, and the tab of each top section may be inserted into one of the tab slots in the base panel.

Features, elements, and aspects described in the context of some embodiments may also be omitted, combined, or replaced by alternative features. Other features, objectives, advantages, and a preferred mode of making and using the claimed subject matter are described in greater detail below with reference to the accompanying drawings of illustrative embodiments.

### BRIEF DESCRIPTION OF THE DRAWINGS

The accompanying drawings illustrate some objectives, advantages, and a preferred mode of making and using some embodiments of the claimed subject matter. Like reference numbers represent like parts in the examples.

FIG. 1 is a top view of an example of an apparatus for receiving ash, residue, and other waste formed from burning cigars, cigarettes, and similarly shaped products.

FIGS. 2-6 are auxiliary views of the apparatus of FIG. 1, illustrating the apparatus in states of partial assembly.

FIG. 7 is another auxiliary view of the apparatus of FIG. 1, illustrating the apparatus in a final state of assembly.

### DESCRIPTION OF EXAMPLE EMBODIMENTS

The following description of example embodiments provides information that enables a person skilled in the art to make and use the subject matter set forth in the appended claims, but it may omit certain details already well known in the art. The following detailed description is, therefore, to be taken as illustrative and not limiting.

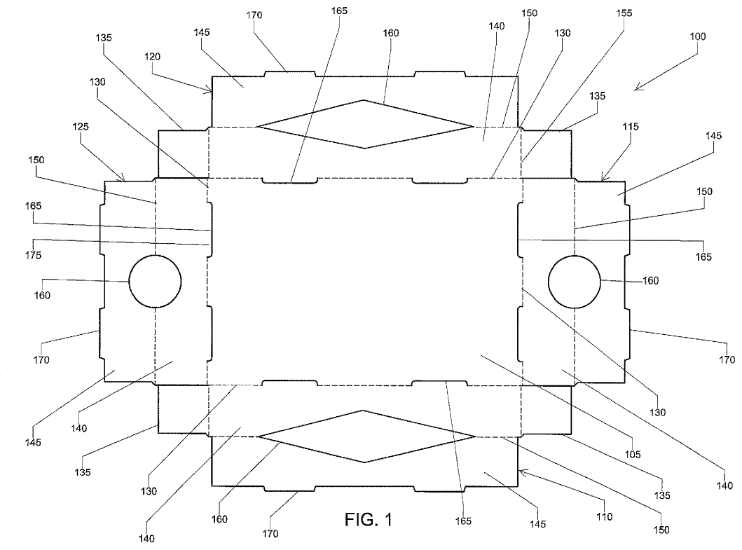

FIG. 1 is a top view of an example of an apparatus 100 for receiving ash, residue, and other waste formed from burning cigars, cigarettes, and similarly shaped products. The apparatus 100 of FIG. 1 is illustrated in a folder box configuration, which may be suitable for distribution and storage. In the example of FIG. 1, the apparatus 100 generally comprises a single, unitary structure of panels in a flat configuration, including a base panel 105, a first side panel 110, a second side panel 115, a third side panel 120, and a fourth side panel 125. Each of the first side panel 110, the second side panel 115, the third side panel 120, and the fourth side panel 125 may be coupled to or otherwise extend from the base panel 105. For example, each may be joined to the base panel 105 at a base fold line 130, as illustrated in FIG. 1. In the example of FIG. 1, the first side panel 110 and the third side panel 120 are similar, and the second side panel 115 and the fourth side panel 125 are similar. Additionally, or alternatively, the base panel 105 may have a substantially quadrilateral profile, and the first side panel 110 and the third side panel 120 may be coupled to or otherwise extend from opposite sides of the base panel 105. Likewise, the second side panel 115 and the third side panel 125 may be coupled to or extend from opposite sides of the base panel 105.

Some embodiments of the apparatus 100 may additionally comprise corner panels 135. Each of the corner panels 135 may be coupled to and extend from one of the side panels. For example, two of the corner panels 135 may extend from opposite ends of the first side panel 110, and two more of the corner panels 135 may extend from opposite ends of the third side panel 120, as illustrated in FIG. 1.

Each of the side panels of FIG. 1 generally comprises a bottom section 140 and a top section 145. Each of the bottom sections 140 may be joined to the top sections 145 at a side fold line 150. Each of the corner panels 135 may also be joined to one of the side panels at a corner fold line 155. Each of the side panels of FIG. 1 also has a hole 160. The holes 160 may have different sizes, shapes, or both. Holes having circular or other symmetrical shapes may be particularly advantageous. As illustrated in the example of FIG. 1, each of the holes 160 is symmetrically aligned with respect to one of the side fold lines 150. In the example of FIG. 1, the holes 160 are shaped as circles and diamonds.

Additionally, or alternatively, the base panel 105 may comprise one or more tab slots 165. In some examples, the tab slots 165 may coincide with the base fold line 130. Each of the top sections 145 may also have one or more tabs 170 adapted to be inserted into the tab slots 165. In some embodiments, the apparatus 100 may also comprise supports 175. As illustrated in the folder box configuration of FIG. 1, the supports 175 may be integral to the bottom sections 140 and may extend into one of the tab slots 165.

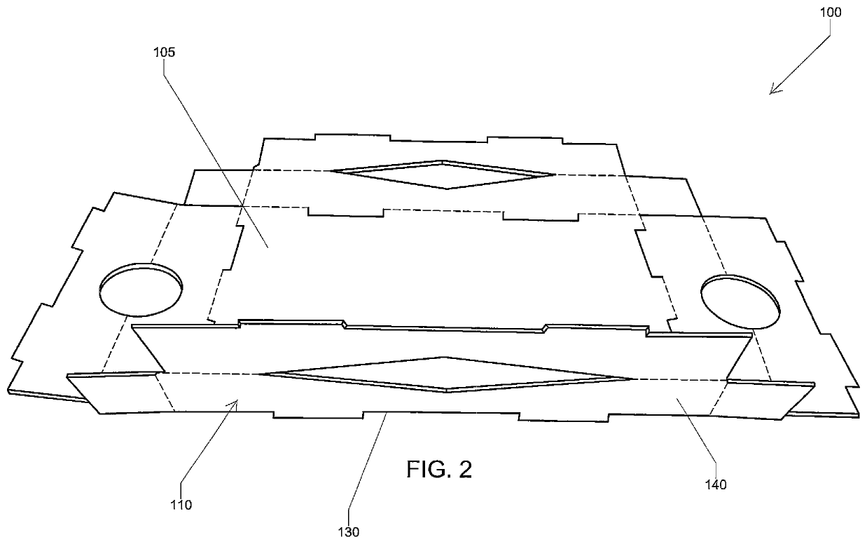

FIG. 2 is an auxiliary view of the apparatus 100 of FIG. 1, illustrating additional details that may be associated with some embodiments. FIG. 2 illustrates the apparatus 100 in a state of partial assembly from the folder box configuration of FIG. 1. For example, the bottom section 140 of the first side panel 110 of FIG. 2 is partially folded relative to the base panel 105. More particularly, the first side panel 110 of FIG. 2 is folded along the base fold line 130.

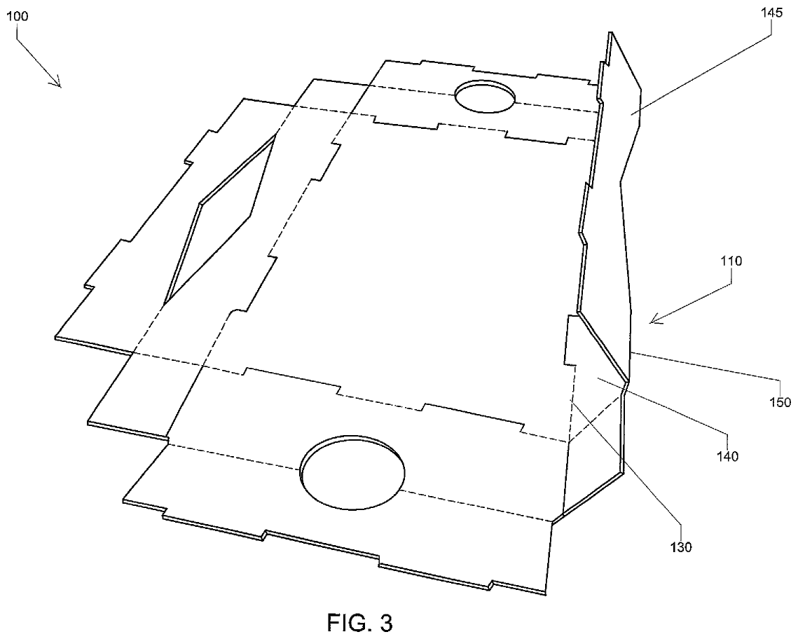

FIG. 3 is another auxiliary view of the apparatus 100 of FIG. 1, illustrating additional details that may be associated with some embodiments. FIG. 3 illustrates the apparatus 100 in another state of partial assembly from the folder box configuration of FIG. 1. In FIG. 3, for example, the bottom section 140 of the first side panel 110 is partially folded at the base fold line 130, as also illustrated in FIG. 2, and the top section 145 of the first side panel 110 is also partially folded at the side fold line 150.

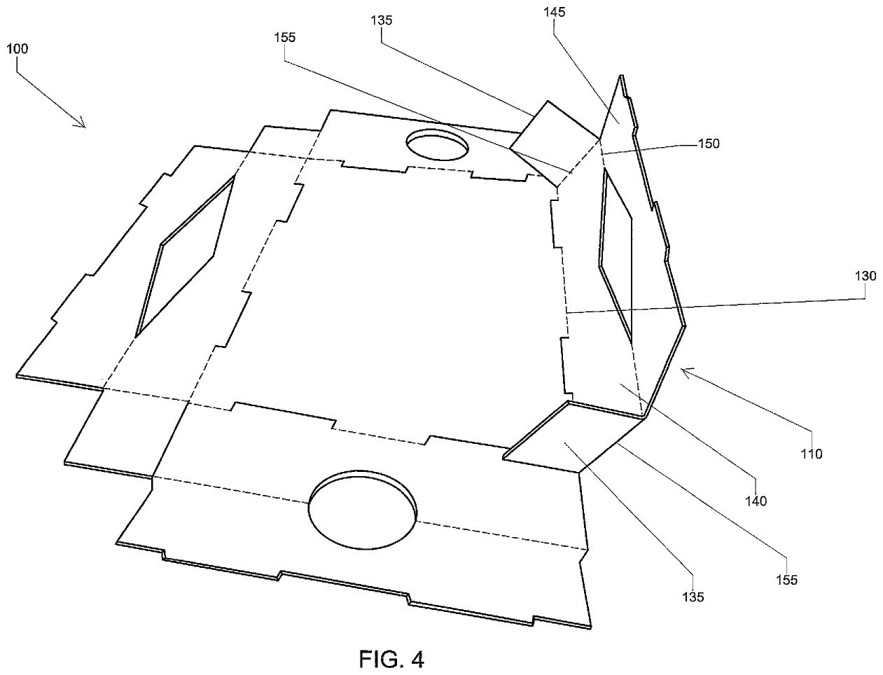

FIG. 4 is another auxiliary view of the apparatus 100 of FIG. 1, illustrating additional details that may be associated with some embodiments. FIG. 4 illustrates the apparatus 100 in another state of partial assembly from the flat configuration of FIG. 1. In FIG. 4, for example, the bottom section 140 of the first side panel 110 is partially folded at the base fold line 130, as also illustrated in FIG. 3, and the top section 145 of the first side panel 110 is also partially folded at the side fold line 150, as illustrated in FIG. 3. Additionally, the corner panels 135 that are coupled to the first side panel 110 are partially folded at the corner fold line 155.

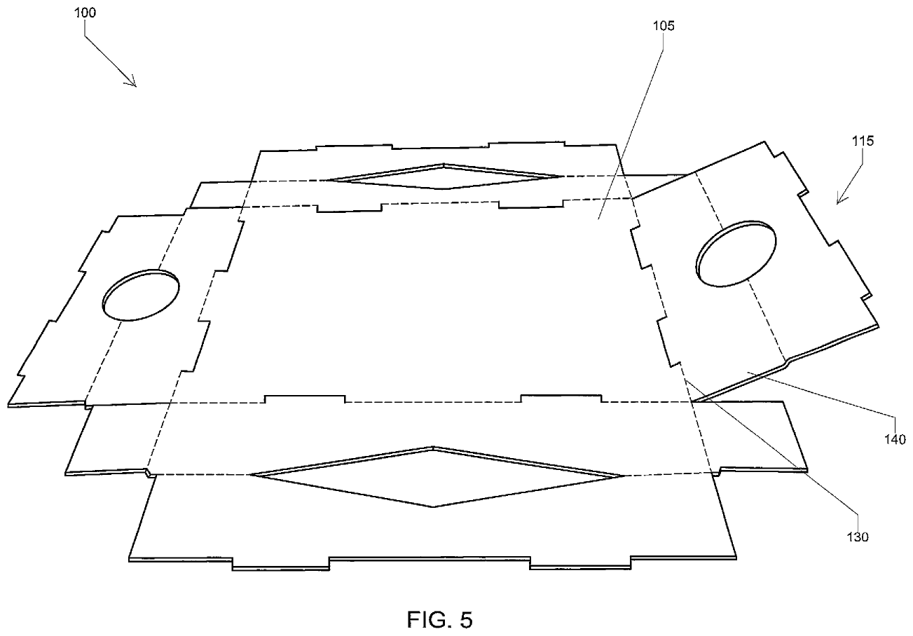

FIG. 5 is another auxiliary view of the apparatus 100 of FIG. 1, illustrating additional details that may be associated with some embodiments. FIG. 5 also illustrates the apparatus 100 in another state of partial assembly from the flat configuration of FIG. 1. For example, the bottom section 140 of the second side panel 115 of FIG. 5 is partially folded relative to the base panel 105. More particularly, the second side panel 115 of FIG. 5 is folded along the base fold line 130.

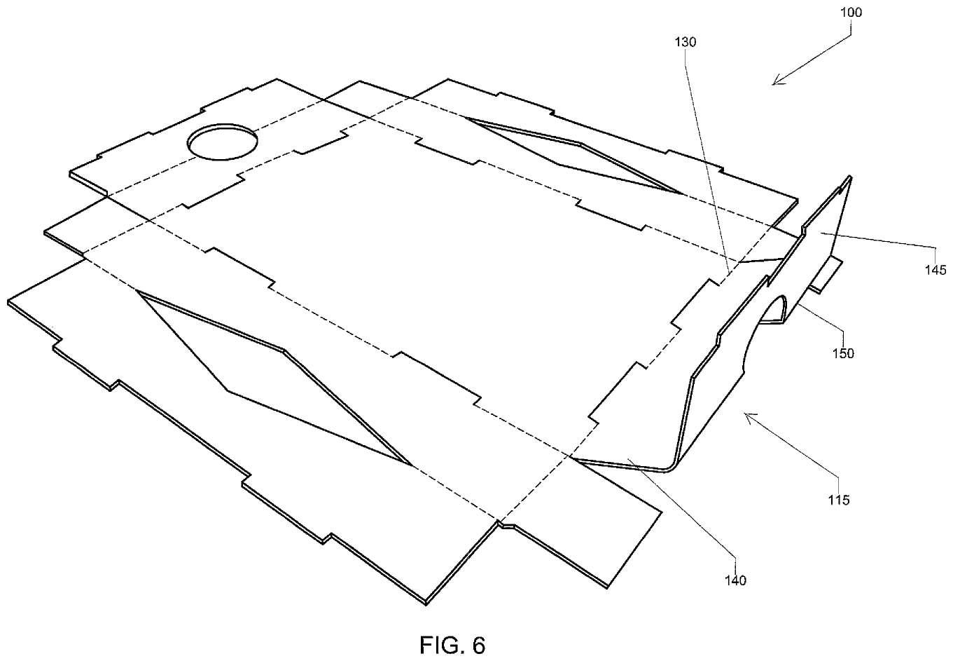

FIG. 6 is another auxiliary view of the apparatus 100 of FIG. 1, illustrating additional details that may be associated with some embodiments. FIG. 6 illustrates the apparatus 100 in another state of partial assembly from the flat configuration of FIG. 1. In FIG. 6, for example, the bottom section 140 of the second side panel 115 is partially folded at the base fold line 130, as also illustrated in FIG. 5, and the top section 145 of the second side panel 115 is also partially folded at the side fold line 150.

Optionally, one or more of the base fold lines 130, the side fold lines 150, and the corner fold lines 155 may be scored, creased, or otherwise marked to facilitate folding the side panels, the corner panels, or both.

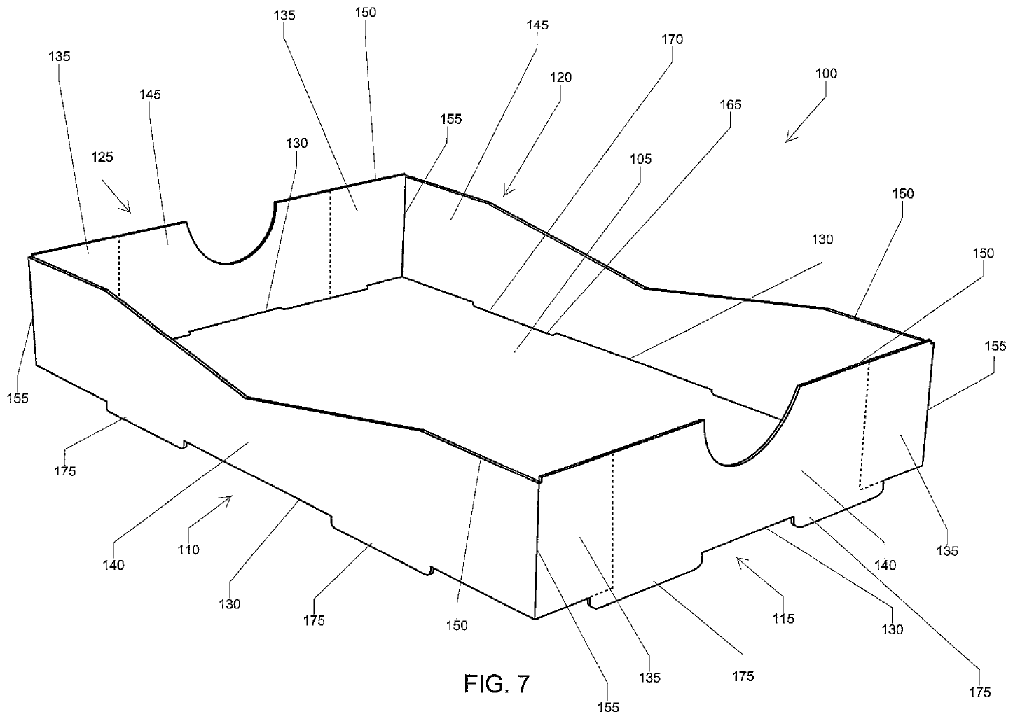

FIG. 7 is another auxiliary view of the apparatus 100 of FIG. 1, illustrating additional details that may be associated with some embodiments in a folded configuration. In the example of FIG. 7, the apparatus 100 has been folded from the initial folder box configuration of FIG. 1. For example, the first side panel 110 has been folded, substantially as described with reference to FIG. 2, FIG. 3, and FIG. 4. The third side panel 120 may also be folded, substantially as the first side panel 110 has been folded. The second side panel 115 has been folded, substantially as described with reference to FIG. 5 and FIG. 6. The fourth side panel 125 may also be folded, substantially as the second side panel 115 has been folded. Additionally, each of the bottom sections 140 has been folded at substantially right angles along the base fold line 130 so that each of the bottom sections 140 is substantially orthogonal to the base panel 105. In the example of FIG. 7, folding the bottom sections 140 also moves the supports 175, rotating them out of the tab slots 165 until they are also substantially orthogonal to the base panel 105. The supports 175 in the example configuration of FIG. 7 can elevate the base panel 105, which can further protect any surfaces beneath the base panel 105. Moreover, each of the top sections 145 has been folded toward the base panel 105 at a substantially straight angle along the side fold lines 150, so that each of the top sections 145 is also substantially inverted relative to the bottom sections 140 and orthogonal to the base panel 105. The corner panels 135 in the example of FIG. 7 extend from the bottom sections 140 of the first side panel 110 and the third side panel 120, and each has been folded toward the opposing side panel at substantially right angles along the corner fold lines 155. In this example, the top sections 145 of the second side panel 115 and the fourth side panel 125 may be folded over the corner panels 135, so that each of the corner panels 135 is secured between the bottom section 140 and the top section 145 of the second side panel 115 and the fourth side panel 120. Additionally, or alternatively, each of the tabs 170 may also be inserted into a corresponding tab slot 165, as illustrated in FIG. 7, to secure the top sections 145 in the folded configuration, thereby increasing structural integrity.

Configured as illustrated in the example of FIG. 7, each of the holes 160 forms a notch, groove, or similar feature for holding cigars, cigarettes, and similar products. So assembled, the base panel 105, the first side panel 110, the second side panel 115, the third side panel 120, and the fourth side panel 125 may also provide a stable receptacle area for ash, residue, and other waste formed from burning such products.

The apparatus 100 may be formed from a variety of flexible materials. For example, some embodiments of the apparatus may be formed from paper, corrugated cardboard, or similar materials, which may be treated to be fire resistant and heat resistant. In some examples, the apparatus may comprise or consist essentially of some combination of such materials. Aluminum foil board or aluminum foil paper may be particularly advantageous for providing flexibility and flame resistance.

The systems, apparatuses, and methods described herein may provide significant advantages. For example, the apparatus 100 can provide a portable receptacle that is easy to assemble and cost-effective enough to be disposable after a single use. The apparatus may be used for cigars, cigarettes, and other cylindrical or similarly shaped products designed for burning or smoking. Additionally, or alternatively, some embodiments may be biodegradable or recyclable.

While shown in a few illustrative embodiments, a person having ordinary skill in the art will recognize that the systems, apparatuses, and methods described herein are susceptible to various changes and modifications that fall within the scope of the appended claims. Moreover, descriptions of various alternatives using terms such as “or” do not require mutual exclusivity unless clearly required by the context, and the indefinite articles “a” or “an” do not limit the subject to a single instance unless clearly required by the context.

The claims may also encompass additional subject matter not specifically recited in detail. For example, certain features, elements, or aspects may be omitted from the claims if not necessary to distinguish the novel and inventive features from what is already known to a person having ordinary skill in the art. Features, elements, and aspects described in the context of some embodiments may also be omitted, combined, or replaced by alternative features serving the same, equivalent, or similar purpose without departing from the scope of the invention defined by the appended claims.

What is claimed is:

1. An apparatus for receiving ash, the apparatus comprising:
a base panel having tab slots;
a plurality of side panels, each of the side panels comprising a bottom section extending from the base panel, a top section coupled to the bottom section and having a tab;
a base fold line between the base panel and each of the side panels;
a side fold line in each of the side panels between the bottom section and the top section; and
a hole in each of the side panels, each hole aligned with the side fold line;
wherein each of the bottom sections is configured to be folded at a substantially right angle along the base fold line, and each of the top sections is configured to be folded at a substantially straight angle along the side fold line to allow each tab to be inserted into one of the tab slots in the base panel.

2. The apparatus of claim 1, further comprising one or more corner panels, wherein each of the corner panels extends from one of the side panels.

3. The apparatus of claim 1, wherein the hole in each of the side panels is symmetrical.

4. The apparatus of claim 1, wherein the hole in each of the side panels is a circle or a diamond.

5. The apparatus of claim 1, wherein the hole in each of the side panels forms a notch or groove if the top section is folded along the side fold line.

6. The apparatus of claim 1, wherein the base panel and the side panels comprise or consist essentially of a material that is resistant to fire.

7. The apparatus of claim 1, wherein the base panel and the side panels comprise or consist essentially of aluminum foil board or aluminum foil paper.

8. An apparatus for receiving ash, the apparatus comprising:
a base panel comprising a first tab slot, a second tab slot, a third tab slot, and a fourth tab slot;
a first side panel having a first side fold line, a first hole aligned with the first side fold line, and a first tab;
a second side panel having a second side fold line, a second hole aligned with the second side fold line, and a second tab;
a third side panel having a third side fold line, a third hole aligned with the third side fold line, and a third tab;
a fourth side panel having a fourth side fold line, a fourth hole aligned with the fourth side fold line, and a fourth tab; and
wherein the first side panel, the second side panel, the third side panel, and the fourth side panel extend from the base panel to form a base fold line around the base panel;
wherein the first side panel and the third side panel extend from opposite sides of the base panel, and the second side panel and the fourth side panel extend from opposite sides of the base panel;
wherein the first side panel, the second side panel, the third side panel, and the fourth side panel are configured to be folded at substantially right angles along the base fold line;
wherein the first side panel, the second side panel, the third side panel, and the fourth side panel are configured to be folded at substantially straight angles along the first side fold line, the second side fold line, the third side fold line, and the fourth side fold line, respectively;
wherein the first tab, the second tab, the third tab, and the fourth tab are configured to be inserted into the first tab slot, the second tab slot, the third tab slot, and the fourth tab slot, respectively, if the first side panel, the second side panel, the third side panel, and the fourth side panels are folded at substantially straight angles;
wherein the first hole, the second hole, the third hole, and the fourth hole are configured to form a notch or groove in the first side panel, the second side panel, the third side panel, and the fourth side panel, respectively, if the first side panel, the second side panel, the third side panel, and the fourth side panels are folded at substantially straight angles; and
wherein the base panel comprises or consists essentially of a material that is resistant to fire.

9. The apparatus of claim 8, wherein the first hole, the second hole, the third hole, and the fourth hole are symmetrical relative to the first side fold line, the second side fold line, the third side fold line, and the fourth side fold line, respectively.

10. The apparatus of claim 8, wherein the first hole and the second hole have a diamond shape, and the third hole and the fourth hole have a circular shape.

11. The apparatus of claim 8, wherein the base panel, the first side panel, the second side panel, the third side panel, and the fourth side panel comprise or consist essentially of aluminum foil board or aluminum foil paper.

12. A method for assembling a receptacle for ash, the method comprising:
providing a folder box comprising:
a base panel having tab slots, and
a plurality of side panels, each of the side panels comprising a bottom section joined to the base panel and forming a base fold line between the bottom section and the base panel, a top section coupled to the bottom section and having a tab, a side fold line between the bottom section and the top section, and a hole aligned with the side fold line;
folding each bottom section at a substantially right angle along the base fold line so that each bottom section is substantially orthogonal to the base panel;
folding each top section at a substantially straight angle along the side fold line; and
inserting the tab of each top section into one of the tab slots in the base panel;
wherein the folder box comprises or consists essentially of a flame-resistant material.
